(19) United States
(12) Patent Application Publication
(10) Pub. No.: US 2020/0355646 A1
(43) Pub. Date: Nov. 12, 2020

(54) SYSTEMS FOR DETECTION OF VOLATILE IONS AND RELATED METHODS

(71) Applicant: C2Sense, Inc., Cambridge, MA (US)

(72) Inventors: Timothy Manning Swager, Newton, MA (US); Joseph J. Walish, West Roxbury, MA (US); John Benjamin Goods, Woburn, MA (US); Robert Deans, Grafton, MA (US)

(73) Assignee: C2Sense, Inc., Cambridge, MA (US)

(21) Appl. No.: 16/825,279

(22) Filed: Mar. 20, 2020

Related U.S. Application Data
(60) Provisional application No. 62/821,817, filed on Mar. 21, 2019.

(51) Int. Cl. G01N 27/62; G06K 7/10; G06K 7/14

(52) U.S. Cl. CPC G01N 27/622; G06K 7/1408; G06K 7/1097

(57) ABSTRACT

Components, systems, and methods for detection of volatile ions and related methods are generally provided. In some embodiments, the components, systems, and methods are configured for use with mass and/or ion mobility spectrometry. In some embodiments, a characteristic of an article (e.g., identity, authenticity, property, adulteration, product associated information such as age or quality, etc.) may be determined by determining the presence (e.g., an amount) or absence of one or more ionic species emanating from the article. For example, the presence or absence of the one or more ionic species emanating from the article identifies a characteristic of the article. In some embodiments, the one or more ionic species have been proactively added to the article.

### RELATED APPLICATIONS

This application is a Non-Provisional of Provisional (35 USC 119(e)) of U.S. Application Ser. No. 62/821,817, filed Mar. 21, 2019, entitled “SYSTEMS FOR DETECTION OF VOLATILE IONS AND RELATED METHODS”.

### FIELD

Embodiments described herein generally relate to systems for the generation and/or detection of volatile ions and related methods for applications such as article identification and/or authentication.

### BACKGROUND

Traditional methods for identifying or authenticating articles include, for example, logos, machine readable barcodes, inventory control systems, serial numbers, and RFID tags. However, these methods can generally only store limited amounts of data and are subject to, for example, counterfeiting.

Accordingly, improved methods and systems are needed.

### SUMMARY

Components, systems, and methods for the generation and/or detection of volatile ions and related methods are generally provided. In some embodiments, the components, systems, and methods are configured for use with mass and/or ion mobility spectrometry.

In one aspect, labels are provided. In some embodiments, the label comprises a means for associating the label with an article and a tag associated with the label, the tag comprising at least one analyte capable of generating an ionic species under a set of conditions, wherein the ionic species is associated with a characteristic of the article, and wherein the ionic species is identifiable by mass and/or ion mobility spectrometry.

In another aspect, methods for identifying a characteristic of an article are provided. In some embodiments, the method comprises ionizing or volatilizing an analyte associated with the article such that one or more ions are generated, the analyte having been proactively added to the article; and detecting the presence of the one or more ions, wherein the detection or absence of the one or more ions identifies a characteristic of the article.

In some embodiments, the method comprises positioning a mass or ion mobility spectrometer proximate an article suspected of containing a tag, volatilizing one or more analytes such that one or more ionic species is generated from the tag, detecting, using the mass or ion mobility spectrometer, the presence or absence of the one or more ions volatilized from the chemical tag, and determining, if the one or more ions are present or absent, a characteristic of the article.

In yet another aspect, systems configured for identification of an article are provided. In some embodiments, the system comprises a label associated with the article, the label comprising a tag, the tag comprising one or more analytes capable of generating an ionic species under a set of conditions, and a component configured for volatizing the analyte such that the ionic species is generated, wherein presence or absence of the one or more ionic species is configured to be detected, by a detector, the detector comprising a mass or ion mobility spectrometry component, and wherein the one or more ionic species are associated with a characteristic of the article.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

FIG. 1A is a schematic diagram of an article and a chemical tag associated with the article, according to one set of embodiments;

FIG. 1B is a schematic diagram of an article, a label, and a chemical tag associated with the label, according to one set of embodiments; and

FIGS. 2A-2D are plots showing identification of exemplary analytes, according to one set of embodiments.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

Components, systems, and methods for the generation and/or detection of volatile ions and related methods are generally provided. In some embodiments, the components, systems, and methods are configured for use with mass and/or ion mobility spectrometry. In some embodiments, a characteristic of an article (e.g., identity, authenticity, property, adulteration, product associated information such as age or quality, etc.) may be determined by determining the presence (e.g., an amount) or absence of a volatile material (e.g., an ionic species) emanating from the article. For example, the presence or absence of the one or more ionic species or other volatile material emanating from the article identifies a characteristic of the article. In some embodiments, the one or more ionic species have been proactively added to the article. That is to say, in some embodiments, the one or more ionic species are not inherently associated with the article but is added in order to, for example, identify a characteristic of the article. In some embodiments, a label may be associated with the article. In some embodiments, the label comprises a tag (e.g., a chemical tag) capable of producing an ionic species (e.g., a volatile ionic species) for detection. In some embodiments, the analyte capable of generating an ionic species are inherently associated with the article but are not present in an amount desirable for implementation of the invention, thus more are added for this purpose. In some embodiments, the one or more ionic species are associated with the label such that the presence or absence of the one or more ionic species (e.g., generated from the analyte and/or label) identifies a characteristic of the associated article.

Without wishing to be bound by theory, in some embodiments, one or more ionic species are detected as a result of their charge to mass ratios and/or their effective cross-sections that cause collisions with gas flowing in a direction counter to the direction of ion movement. The methods for the detection of ionic species include, for example, mass spectrometry and ion mobility spectrometry. The invention disclosed herein generally involves the triggered generation of signatures encoded chemically and/or spatially that give rise to an identifying characteristic of an article (e.g., a unique identification code) that, for example, cannot generally be easily replicated or reverse engineered. For example, the chemical codes may allow for confirmation of the authentic nature of an article (anti-counterfeiting) and track & trace applications for monitoring and maintenance of supply chains.

In some embodiments, the inventive aspects described herein are directed at the generation of signatures that can be read by mass spectrometric or ion mobility methods. For example, there are numerous types of mass spectrometers including systems referred to as ion cyclotron resonance, time of flight, quadrupole, and ion traps. In some cases, MS-MS methods are performed wherein an individual ion is captured by the mass spectrometer and then subsequently fragmented to give what is referred to as a secondary ion for detection. Any type of mass spectrometer may be suitable for use with the methods and systems described herein. In certain embodiments devices that are portable and/or hand-held will be particularly useful. Similarly, any type of ion mobility spectrometer may be used with this method and different types of drift tubes and gas mixtures can be used depending upon the nature of the species to be detected. Advantageously, the methods and systems described herein, when coupled with various ionization techniques, vaporization/release methods, and spatial pattering may give rise, in some cases, to a large number of combinations of codes with enough complexity to effectively render the system impossible, or at least economically impractical, to duplicate. The ability to uniquely label an article has value to the manufacturer or brand owner to authenticate the manufacturing point-to-origin, date, batch, quality and provenance of the article as it traverses the supply chain.

In some embodiments, the detection by a detector of at least one or two or more ionic species may identify a characteristic of the article. For example, two different ionic species may be proactively added to the article. Detection, by a detector (e.g., a mass spectrometer), of both of the two ionic species may indicate the authenticity of the article. By contrast, a detector which detects zero or one of the two ionic species may indicate that the article is not authentic. Those of ordinary skill in the art would understand, based upon the teachings of this specification, that the presence (or absence) of one or more ionic species associated with the article may identify one or more characteristics of the article as described in more detail herein (e.g., age, quality, origin, identity, etc.).

In some embodiments, a tag (e.g., a chemical tag) comprises an analyte capable of generating one or more ionic species (e.g., upon volatilization of the analyte) under a set of conditions. In some embodiments, the tag comprises one or more, two or more, three or more, four or more, five or more, six or more, seven or more, eight or more, nine or more or ten or more different analytes capable of generating volatile ions (e.g., ionic species). In some embodiments, detection of the presence (or absence), of at least one of the one or more (or two or more, etc.) ionic species generated from the tag identifies a characteristic of the article. For example, in some embodiments, detection of all of the ionic species released from the tag identifies the characteristic of the article. In some embodiments, detection of at least a portion of the ionic species released from the tag identifies the characteristic of the article. In some embodiments, the detection of none of the ionic species released from the tag identifies the characteristic of the article. As described herein, detection may include measurement (e.g., by mass or ion mobility spectrometry) of the presence or the absence of one or more ionic species which may be used to identify one or more characteristics of the article.

In some embodiments, each species capable of generating volatile ions from the chemical tag may be volatile or non-volatile. For example, in some embodiments, a first analyte capable of generating a first volatile ionic species may be selected such that it is volatile and passively releases (e.g., emanates) the analyte (e.g., that can give rise to the ionic species) and/or ionic species from the article. Such compounds may be useful for, for example, determining if the article has passed its shelf life. In some embodiments, a second analyte capable of generating a second volatile ionic species, the same or different from the first analyte, may be selected such that it is non-volatile and the second ionic species may be triggered to be released (e.g., emanate) from the article such that it may be detected by a detector.

In some embodiments, the one or more ionic species are volatized such that they may be detected (e.g., by mass or ion mobility spectrometry). In some embodiments, the one or more ionic species may be volatized using by a high intensity light source (e.g., matrix assisted laser desorption ionization (MALDI)) or by binding molecules to selected substrates (e.g., surface assisted laser desorption/ionization (SALDI)), as described in more detail herein.

In some embodiments, the tag (e.g., chemical tag) comprises a plurality of identifiable (e.g., by one or more detectors) chemical compounds (i.e. analyte) capable of generating an ionic species (e.g., a volatile ionic species). In some embodiments, the tag may comprise one or more analytes capable of generating volatile ions, the analyte inherently associated with the article, but not present in an amount desirable for implementation of the systems and methods described herein, and thus more is added for this purpose. In some embodiments, the tags described herein may be useful for additional applications. For example, in some embodiments, the tag may be associated with an ink (e.g., such as for a barcode), a preservative, a flavoring, a fragrance, a colorant (e.g., a dye), a protective coating, and/or a structural element (e.g., glue, tape, strapping, packaging) associated with the article (or label).

The systems and methods described herein may be useful for a number of applications. For example, in some embodiments the systems and methods described herein may be used for product identification, product authentication, or the like. For example, in some embodiments, the characteristic of the article may include the identity of the article, point of origin of the article, the location of the article, the authenticity (or counterfeit nature) of the article, the quality of the article, the age of the article, whether the article is new or used, deterioration of the article, mishandling of the article, tampering of the article, or the like. Such characteristics may be useful for, for example, detecting theft, detecting unauthorized distribution, identifying illegal sales, identifying counterfeit products, identifying adulterated products, quality control, quality assurance, and tracking of the article.

As an illustrative embodiment, in some embodiments, the chemical tag may be used to detect degradation (e.g., a characteristic) of the article due to, for example, exposure to extreme temperatures, changes in moisture and/or humidity, exposure to light and/or chemical reactants, sterilization processes, or radiation). For example, in some such embodiments, the analyte and/or one or more ionic species may be volitalized, released, and/or degraded by such temperatures, moisture, humidity, light, and/or reaction with particular chemicals, sterilization processes, or radiation. In some embodiments, the release under degradation of the one or more ionic species may be detected thereby identifying the degradation (or other characteristic) of the article.

In some embodiments, a first portion of a first ionic species is triggered to release (e.g., volatize, ionize) under a first set of conditions and a second portion of the first ionic species is triggered to release under a second set of conditions, different than the first set of conditions.

In some embodiments, a first portion of a first ionic species is triggered to release under a first set of conditions and the first ionic species is not released under a second set of conditions, different than the first set of conditions.

In some embodiments, at least a portion of a first ionic species is triggered to release under a first set of conditions and at least a portion of a second ionic species is triggered to release under a second set of conditions, different than the first set of conditions.

In some embodiments, at least a portion of a first ionic species and at least a portion of a second ionic species is triggered to release under a first set of conditions. In some embodiments, the first ionic species and/or the second ionic species does not release under a second set of conditions, different than the first set of conditions.

In some embodiments, the chemical tag may be applied to an article and a record of the characteristic of the article associated with that chemical tag may be made. For example, in some embodiments, the identity of the article may be confirmed if a particular chemical tag is detected by a detector.

The chemical tags described herein may be implemented in any suitable manner. For example, the chemical tag may be associated with a label. In some embodiments, the chemical tag and/or label may be single use or designed for multiple (e.g., repeated) use.

In some embodiments, the chemical tags described herein may be combined with one or more additional identifying components. For example, in some embodiments, a label may comprise a tag (e.g. an analyte capable of generating volatile ions) and a second identifying component, different than the tag. In some embodiments, a first label comprising the tag and a second label comprising the identifying component may each be associated with an article. For example, in some embodiments, the tag (or label) may be associated with a single or multidimensional optical barcode. Those of ordinary skill in the art would understand, based on the teachings of this specification, how to select additional identifying components for use with the tags and systems described herein. In some embodiments, the article is associated with a tag (or label comprising the tag) and a second identifying component such as an optical barcode, hologram, RFID, luminescent material, electrical conductor, and/or additional markers and/or biological markers. Nonlimiting examples of additional markers and/or biological markers that may be used in conjunction with the systems described herein include, but are not limited to, colorimetric dyes, fluorescent dyes, IR dyes, watermarks, nanoparticles, carbon nanotubes, nanorods, quantum dots, antibodies, proteins, nucleic acids, and combinations thereof.

In some embodiments, the label comprises barcodes, decorative elements, quality indicators, or even be part of structural elements of an article. The tag(s) and/or label may also contain other information that may be read by very simple systems. For example, the label may comprise other optical signatures including holograms, fluorescence, reflectivity, colors, optically induced color changes, resistivity, or the like. In some embodiments, the label may be configured to emit gas signatures that may be read by gas detectors. In some embodiment, the label may form at least a portion of a conductive antenna (e.g., that provides for a radio frequency identification (RFID) method). In some embodiments, the label may be integrated into an electrical circuit (e.g., having information ranging from a simple resistivity or diode behavior, to frequency dependent behavior, and/or produce digitally encoded signals). In some embodiments, the electrical circuit may be used for a lower level of authentication (e.g., advantageously the readers may be relatively inexpensive and readily abundant). In some embodiments, the label may be configured to be read at the consumer level e.g., by use of a smart phone or other inexpensive devices. Advantageously, such methods may provide a network of devices with frequent readings, may provide temporal and spatial information about the locations of articles or potential counterfeit articles, and/or may provide then ultimate validation by the generation and release of volatile ionic signatures as described herein.

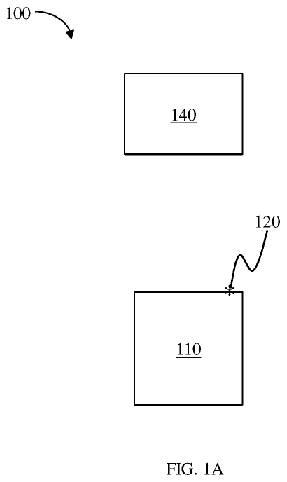

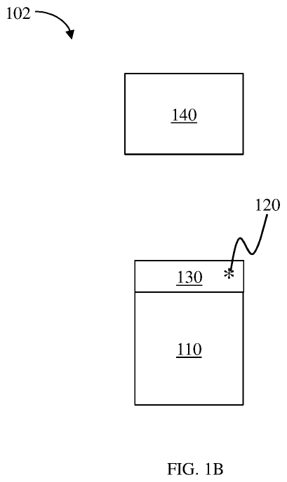

Turning now to the figures, as illustrated in FIG. 1A, in some embodiments, system 100 comprises an article 110 and a tag 120 (e.g., chemical tag) associated with article 110. In some embodiments, tag 120 comprises one or more analytes capable of generating an ionic species. In some embodiments, as described herein, the release one or more ionic species may identify characteristic of article 110. In some embodiments, detector 140 may be used to detect the presence (or absence) of tag 120 and/or the one or more analytes capable of generating volatile ions tag 120 comprises. In some embodiments, chemical tag 120 may be positioned proximate, adjacent, or directly adjacent article 110.

The term “associated with” as used herein means generally held in close proximity, for example, a chemical tag associated with an article may be adjacent a surface of the article. As used herein, when a chemical tag is referred to as being “adjacent” a surface, it can be directly adjacent to (e.g., in contact with) the surface, or one or more intervening components (e.g., a label) may also be present. A chemical tag that is “directly adjacent” a surface means that no intervening component(s) is present. In some embodiments, the chemical tag is adjacent a surface of the article. In some embodiments, the chemical tag is directly adjacent a surface of the article. In some embodiments, the chemical tag is incorporated into the article (e.g., is present within the bulk of at least a portion of the article but, absent the addition of the chemical tag to the article, would not be inherently present in the article itself or not present in an amount desirable for implementation of the systems and/or methods described herein).

In some embodiments, the chemical tag is associated with the article and adjacent (e.g., directly adjacent) a label, the label associated with the article. For example, as illustrated in FIG. 1B, system 102 comprises article 110 and chemical tag 120 associated with article 110. In some embodiments, a label 130 is associated with article 110. In some embodiments, chemical tag 120 is associated with label 130. In some embodiments, label 130 comprises one or more compounds forming chemical tag 120. In some embodiments, the label is adjacent the article. In some embodiments, the label is directly adjacent (e.g., affixed to) the article. In some embodiments, the label is proximate the article but not necessarily adjacent the article. For example, in some embodiments, the label may be present in a container containing at least a portion of the article

The term “label” as used herein is given its ordinary meaning in the art and generally refers to a component (e.g., comprising paper, fabric, plastic, ink, electronic device, or other material) associated with an article and giving information about said article. In an exemplary embodiment, the label is a sticker that contains functionality. In another exemplary embodiment, the label is a marker. In yet another exemplary embodiment, the label is a stamp. In other embodiments the label is printed or sprayed on an article.

In some embodiments, the label is mechanically abraded, and/or embedded onto at least a surface of the article. For example, an article comprising the analyte (e.g., the analyte comprising the ionic species) may be mechanically abraded against a surface of the article such that at least a portion of the analyte is deposited on the surface of the article.

Other labels are also possible and means for associating labels with an article are described in more detail below.

The chemical tags and labels described herein may be applied to the article on any suitable manner. For example, in some embodiments, the chemical tag and/or label may be applied at one or more (e.g., two or more, three or more, four or more, five or more) or at a plurality of spatially distinct locations. For example, in some embodiments, the article comprises one or more (or two or more, etc.) chemical tags, wherein each chemical tag is the same or different. In some embodiments, each chemical tag may identify a same or different characteristic of the article.

In some embodiments, two or more different analytes capable of generating (an) ionic species may be used to create a unique chemical signature for identification of a characteristic of the article. For example, the presence of a first analyte capable of generating volatile ions and the presence of a second analyte capable of generating volatile ions (each analyte and/or ion not inherently associated with the article e.g., proactively added to the article) may together identify a characteristic of the article.

For example, exposure to sunlight and the associated UV radiation could be measured by the depletion of one chemical tag or the photochemical activation of another chemical tag. In some embodiments, as described herein, multiple chemical tags may be used to provide more detailed information. Similar methods could be used to monitor collective humidity exposure of a product. In some embodiments, a chemical tag could be decomposed or generated by the exposure to water vapor or liquid. For certain applications, chemical tags may be selected that respond to certain chemicals. For example, if food were treated with peroxides or bleach to neutralize bacteria, a tag could be placed that would have indicated the prior exposure or ideally validate that the material had no exposure to these chemicals.

In some cases, it may be desirable to have chemical tags that may be read for months or even years (e.g., are shelf stable). In some embodiments, chemical reactions that occur in response to an added reactant, light, heat, radiation, or mechanochemical stimulus may be used. For example, chemical tag precursors may comprise ionic compounds that have effectively no vapor pressure allowing them to persist for years and the activation process to produce volatile chemical tags may involve the conversion to uncharged materials with volatility allowing for gas detection or ionization and detection by a mass and/or ion mobility spectrometer. In other cases, species capable of generating volatile ions can be strongly bound to a material for long-term stability. In specific cases, the materials could be bound by strong electrostatic interactions or through covalent chemical bonds.

In some embodiments, the chemical tag may be combined with one or more different materials. For example, polymerizations or polymer deposition may, in some cases, be used to form phase separation with polymers and thereby spontaneously form domains of a chemical tag or chemical tag precursor(s) with the polymer. The polymer may be inert and the chemical tag/chemical tag precursor may, in some cases, be released by mechanical disruption of the material or other energetic dissipation within the material. Alternatively, the polymer may be an active element and part of the triggered release, generation, or activation of the chemical tag. The polymer and chemical tag/chemical tag precursor and related elements may be deposited, in some cases, from solution onto a tag or made separately and applied in a lamination step. In some embodiments, the polymer can be produced in situ to make a film comprising the chemical tag. Those of ordinary skill in the art would understand, based upon the teachings of this specification, that the size and density of the chemical tag phase can be controlled by, for example, processing conditions, surfactants and the like. Crosslinking of the polymer host materials or the polymers encapsulants used in colloid production may be used, in some cases, to modulate the diffusion through these materials. Such crosslinks may be designed to be removed upon exposure to a chemical, photochemical, enzymatic, mechanical, electrochemical, or thermal process.

Any suitable polymer may be used. For example, in some embodiments, the polymer may be kinetically stable (and thermodynamically unstable) such that it will generally spontaneously depolymerize with a bond rupture. An example of such a class of polymers are the poly(vinyl sulfones), which, without wishing to be bound by theory, when fragmented at room temperature will spontaneously depolymerize. Such materials have a broad compositional range and have generally been shown to be sensitive to radiation, base, electron transfer (redox), and thermal processes. Such polymers may be useful for the fabrication of polymer capsules comprising the chemical tags, described herein. Other polymers are also possible and those of ordinary skill in the art would be capable of selecting such polymers based upon the teachings of this specification.

In some embodiments, the analyte capable of generating an ionic species can be added to ink used to print labels or bar codes. Non-limiting examples include graphite, graphene, carbon, or carbon nanotube, metal nanoparticle, metal oxide, polymer or dye based inks. In some embodiments, use of different labeled inks to print a pattern taggants can be spatially encoded. In an illustrative example, each bar of a bar code includes one or more different taggants.

The one or more chemical compounds may be applied to the article and/or label using any suitable means. Non-limiting examples of deposition methods include spray coating, dip coating, evaporative coating, ink jet printing, imbibing, screen printing, pad printing, gravure printing or lamination. In some embodiments, the one or more chemical compounds may be bound to the label or article via formation of a bond, such as an ionic bond, a covalent bond, a hydrogen bond, Van der Waals interactions, and the like. The covalent bond may be, for example, carbon-carbon, carbon-oxygen, oxygen-silicon, sulfur-sulfur, phosphorus, nitrogen, carbon-nitrogen, metal-oxygen, or other covalent bonds. The hydrogen bond may be, for example, between hydroxyl, amine, carboxyl, thiol, and/or similar functional groups.

In some embodiments, the tag need not be persistent and may slowly or quickly evaporate from a tag over time, decompose over time, or become irreversibly bound to the tag over time. Such a mechanism may also be used to provide for an expiration of a product and/or give an indication of the conditions upon which the object to be authenticated was exposed. For example, if a material has a cumulative thermal exposure, it could result in the depletion of one or more of the chemical compounds in the chemical tag. In some embodiments, identification of a characteristic of the article may also provide information about the status of the product.

The labels described herein may comprise any suitable substrate for containing or otherwise associating the chemical tag with the article. For example, in some embodiments, the label may comprise a substrate, and a chemical tag (e.g. comprising one or more chemical compounds) associated with the substrate. Non-limiting examples of suitable substrates include silicone, silica, glass, metals, microporous materials, nanoporous materials, polymers, gels, and natural materials (e.g., paper, wood, rocks, diamonds, gems, tissues, hair, fur, leather).

In some embodiments, the label comprises a means for attaching the label to an article. Non-limiting examples of suitable means for attaching the label include adhesives, lamination, melt bonding, spray coating, spin coating, printing, strapping, and combinations thereof.

In some embodiments, the chemical tag and/or label may be applied to articles in many ways and the composite materials can have multiple functions. For example, a printed label can yield a logo or pattern wherein part, or all, of the label is capable of generating unique information when read by a chemical reader.

For a chemical encoding (e.g., the use of a chemical tag as described herein) to be detected by a mass spectrometer or ion mobility spectrometer the molecule(s) may be, in some cases, in the gas phase and ionized. In some embodiments, for taggants that are not intrinsically ionic, ionization may occur, in some cases, as part of the vaporization process or in a sequential process. In some embodiments, the ionization methods involve the use of ionizing radiation given off from high energy photons, multiphoton processes, nuclear decay of unstable isotopes, bombardment with other ions, electron impact, electrical discharge, alternating electric fields, collisions with other gases or surfaces, thermal dissociation, droplet charging, electrospray/solvent spray or high static electric fields. The systems described herein may be used with any of these methods or their equivalents.

In some embodiments, the charges in the volatile molecular or atomic species (e.g., the ionic species) may be positive or negative and need not be unity but can be an integer value such as +1, +2, +3, +4, −1, −2, −3, −4 or potentially species of higher positive or negative charge. The degree of charge on the species may depend, in some cases, upon the structure and the absolute mass. For example, larger mass species may be capable of bearing larger amounts of charge. In certain embodiments, species with greater mass to charge ratios may be useful as these enable the use of, for example, lower resolution, less expensive detection equipment.

In some embodiments, the volatile materials (e.g., ionic species) may be formed by thermal, photochemical, radiological, electrical, optical, mechanical, tribological, and/or chemically triggered events. In certain embodiments, these methods will produce neutral gasses that are then ionized and analyzed by established methods including those mentioned above. In other embodiments, it may be advantageous to have the materials vaporized and ionized at the same time.

In some embodiments, the volatile material is within a matrix material that is designed to promote the generation of ionic species. In the case that such a material is volatized by a high intensity light source such as a laser this method is generally known as matrix assisted laser desorption ionization (MALDI). The matrix material may be colored or colorless and may be integrated into an article in a way that appears to be part of a label intended for visual inspection or an optical code such as a one-dimensional linear barcode or a two-dimensional computer readable image (barcode) known as a data matrix code. In the case of a MALDI label the matrix may, in some cases, provide a background signal of ions, which may be part of the code detected by the mass spectrometer of ion mobility spectrometer. The encoding chemical signature may, in some cases, be encoded to give ion signals that are similar to the ions associated with the matrix material or at high mass to charge ratios that are clearly resolved from the matrix material by the mass spectrometer or ion mobility spectrometer.

In some embodiments, vaporization and ionization is accomplished by binding molecules to particular substrates. These methods are generally known as surface assisted laser desorption/ionization (SALDI) and generally make use of materials capable of being excited by lasers that to not necessarily fragment but volatilize and/or ionize materials that are bound to their surfaces. These surfaces may include metals, polymers, high surface-area materials, metal nanoparticles, semiconductors, semiconductor nanoparticles, graphite, graphite nanoparticles, carbon, carbon nanoparticles, graphene, carbon nanotubes, or combinations thereof. Organic molecules, organic/inorganic salts bound to these materials may be efficiently ionized and volatized by laser excitation. In some embodiments, carbon materials and/or nanomaterials are attractive materials as they may be used to form the basis of many inks that can be used to encode barcodes on articles. For example, the inks to coat the different features of a given barcode can be designed to have a chemical tag(s) that can be read by laser excitation. In some embodiments, the chemical tag(s) may be deposited though the deposition of solid materials. For example, modern pencils use graphite composites to create a transferable black material for labeling. Similar composites may be formed with chemical encoding (e.g., a chemical tag as described herein) and used to make articles. Solids can also be placed into packaging as well as the printed labels.

In some embodiments, in which the chemical tags and labels described herein are used in conjunction with an optical barcode, the barcode may be read using commercial barcode readers (e.g., the wavelength and power of such readers will generally not result in substantial generation of ions by the SALDI method). These codes, in some embodiments, can yield standard product information as used currently, wherein each feature (e.g., line) of the barcode may or may not be encoded with one or more unique chemical tag(s) (e.g., comprising one or more species that can be released and read on demand e.g., using a higher power laser excitation). Similar to the optical barcode, the unique signature of the different chemicals can generally be measured. In some embodiments, the entire printed barcode will be uniformly encoded.

In some embodiments, ions generated by the SALDI or MALDI methods may generate complex chemical signatures that can confound, or make economically prohibitive, attempts to reproduce the signature. Without wishing to be bound by theory, the ions generated in many cases may be fragments of complex molecules added to the matrix or bound to surfaces, advantageously hindering the ability to reverse engineer the system. In the case of carbon materials, for example, the encoding species may be bound strong enough that they are not easily released by methods such as thermal treatments or solvent extraction. In some embodiments, the encoding materials will be covalently linked to the support, such that they can only be released by laser excitation or other electromagnetic excitation. The reading of the tag and the specific signature may, in some cases, be protected such that users or those wishing to reverse engineer the system will not be able to understand what in particular is being detected. As a result, in some embodiments, it will be extremely difficult, if not impossible to determine the chemical tag(s) being used. The mass spectrometric and ion mobility spectrometry methods are also generally very sensitive, which may make it extremely difficult to determine the encoding used.

In some embodiments, a direct analysis in real time (DART) ion source may be used in conjugation with the labels and methods described herein (e.g., to ionize a material).

In the case that the molecules are volatized without ionization, the ionization process may be conducted in a secondary process. For example, a pressure gradient or simple passive diffusion may be used to collect the vapors for ionization and identification by mass spectrometric methods. In some embodiments, it may be possible to separate different vapors prior to ionization. For example, a gas chromatograph or absorption materials may be used at the front-end of the mass spectrometer or ion mobility spectrometer.

Although direct sampling of an article may be used, in some embodiments, a sample is collected by swiping an article with a plastic, fabric, paper, or similar substrate. In some such embodiments, the chemical tag is transferred to the swipe material for subsequent ionization or vaporization in a separate process. This method may be useful on, for example, sensitive articles or in cases wherein it is inconvenient to bring the detector proximate to the article or the location on the article that is tagged with the encoded label.

In some embodiments, the encoding materials have considerable complexity. For example, with higher resolution mass spectrometric methods, the encoding could be performed by incorporation of specific isotopes. In some embodiments, a single mass unit difference in a molecule such as a substitution of a hydrogen for a deuterium may be used to create a unique code. Families of ions may be generated, in some cases, and even complex mixtures of biomolecules such as proteins of carbohydrates may be used to create unique signatures. In some embodiments, synthetic polymers are used that have encoded combinations of monomers and/or chain lengths wherein the SALDI or MALDI process yields unique identifiers.

In some embodiments, the chemical tag and/or the matrix or surfaces used for the MALDI or SALDI processes, are non-toxic and are generally approved for consumption (e.g., by humans). In some embodiments, the methods and systems described herein may be used to encode medicines at the unit level including the identification of individual tablets. In some embodiments, chemical tag(s) may comprise a combination of materials that may be, for example, printed or otherwise deposited on tablets, used in the composite coatings of tablets, the capsule around an active ingredient, or directly embedded into the body of the tablet. Liquid formulations could also be tagged such that they could be identified via the methods described herein. Natural materials such as proteins, carbohydrates, edible dyes, etc. may be used to encode tablets/pills. For example, the sequence of proteins may be used to give unique fragmentation patterns. In some embodiments, smaller proteins may be potentially detected as parent ions. As an illustrative example, a protein with twenty different amino acids and a peptide that is only five amino acids long may yield 15,504 different combinations. Beyond parent ions and considering that every permutation of a five-unit peptide may give a unique fragmentation, then the number of permutations that could be potentially detected is 1,860,480. These simple calculations illustrate the complexity that may be easily incorporated using the methods and systems described herein.

Although macromolecules may contain considerable information, encoding that produces small volatile molecular fragments for analysis has advantages including, for example, that instrumentation may be simplified, low cost, and portable. For example, the resolution of a mass spectrometer is generally related in part to the mass to charge ratio (M/Z) of the fragment of interest. By way of example, a given fragment with a charge of ±2 will generally behave as an ion half the mass of the same fragment with a charge of ±1. The mass resolution (M/Z) may, in some cases, depend upon the type of method used to analyze the material. The FT-ICR-MS method is, for example, generally extremely accurate. Time of flight (TOF) mass spectrometry may have intermediate resolution and quadrupole/ion trap systems may have lower resolution. There are generally many sub-types of mass spectrometry methods and some of these methods may be miniaturized into handheld and/or portable systems. In general, analysis of high molecular weight material is more challenging and requires access to more expensive instrumentation. The low volatility of larger fragments may also lead to lower signals and hence more sensitive detection is needed, which may require more expensive instrumentation. Additionally, for larger fragments resolution may be challenging and require more expensive instruments. As a result, smaller molecular fragments, or larger (but still volatile) multiply-ionized fragments, have advantages in that they may be detected with lower cost equipment and more readily generated and collected for analysis. Ideally, smaller ions may be detected using lower cost and portable mass spectrometric or ion mobility spectrometric instrumentation. However, larger and/or higher molecular weight materials may also be used.

Any suitable method of ionization may be used. Methods may range from what are generally known as soft ionization methods that generally yield molecular ions with minimal fragmentation to hard ionization methods that generally yield complete breakdown to give elemental products. There is generally a wide spectrum of methods that are between both extremes and depending on the method used to generate vapors and/or ionization, different degrees of molecular fragmentation are expected. Depending on the application, one or more ionization methods or different levels of energy dissipation may be used in the generation of an authentication signature. Different methods may be used, in some cases, to release different taggants or cause different species of a taggant to be produced for detection. An example of a soft ionization method is what is known as electrospray, wherein a droplet carrying a taggant may be generated. Without wishing to be bound by theory, microscopic aerosols generated under high electric fields may, as a result of statistics, have a different number of positive and negatively charged ionic species within them. For example, rapid evaporation of the droplet may result in large electrostatic forces that give rise to repulsive forces that liberate individual molecular ions from the aerosol particles, often without fragmentation. By way of example, a hard ionization method includes laser induced breakdown spectroscopy (LIBS), wherein an intense laser pulse creates a local plasma when interacting with a surface. This generally results in fragmentation to create elements in excited states that give off atomic emission spectra. The shape emissions from these elements may, in some embodiments, give a signature of the elemental composition of a material. An advantage of the method described above is that fragments may be detected by optical methods. Such a method may, in some cases, be used for rapid detection of tags and naturally correlate an optical signal with each element of a bar code. In some embodiments, the tags comprises encoding that can be read separately under different volatilization/ionization methods with a mass or ion mobility spectrometer.

In some embodiments, methods that contain variable amounts of fragmentation that convey information, but do not immediately reveal the parent structures, may be used. For example, having multiple co-located taggants that are similarly liberated to give ionic fragments may be used to confound attempts to replicate an authentication taggant code.

As described herein, different matrix materials may be used that may be excited by light or other energy sources. In some embodiments, materials that optimally couple to different stimulation(s) and thereby generate signature ions are used. In some embodiments, the materials comprise a solid support including metal nanoparticles, metal oxides, semiconductors, and/or carbon nanomaterials. The taggants may, in some cases, be physically adsorbed or chemically attached to the support. In some embodiments, the nature of the solid support and stimulation may give rise to different distributions of ions that may provide unique authentication signatures. In some cases, the solid support may be effective in generating negative ions and other supports may give rise to positive ions. Mass spectrometric and ion mobility spectrometric instrumentation may be matched to detect ions with positive or negative charge, in some cases.

In some embodiments, excitation of a solid support (e.g., having a high electron affinity) may give rise to oxidation of a chemical tag(s) bound to it and e.g., may generate a positive ion that may be volatized and detected. In some embodiments, excitation of a solid support (e.g., having a low electron affinity) may result in reduction of a chemical tag(s) to generate negative ions that may be volatized and/or detected. In some embodiments, the material could give mixtures of positive or negative ions and the relative abundance of the different types of species can be selected by the types of stimulation applied to the material. For example, in some embodiments, optical excitation may give one type of ion, but thermal methods give a different signature (e.g., type of ion(s)) wherein neutral molecules are volatized that can be ionized and detected by a mass or ion mobility spectrometer.

In some embodiments, the chemical tag(s) and/or solid supports are electronically active. In some embodiments, the chemical tag(s) and/or solid supports may interact strongly with applied electromagnetic or electric fields. For example, nanocarbons and metal nanoparticles may be excited readily by optical methods. DC or AC electric fields, or even microwaves. In some cases, the excitation of each of said materials may be localized and/or may be used to scan an article to read a spatial pattern of taggants. In some embodiments, different solid supports have different efficiencies for interacting with fields. For example, graphite and carbon nanotubes, which are generally electrically conductive may be readily excited by microwave radiation. In some embodiments, a solid organic matrix may not be as easily excited, e.g., unless the frequency of the microwave radiation overlaps with an absorption band in the target material. In this way, at low microwave powers, ion fragments may be released from carbon nanotubes, but not the other matrix. However, in other embodiments, ion fragments may be released from the other matrix and not e.g., the carbon nanotubes.

Microwave excitation may be delivered via continuous wave (CW), pulsed sources, and/or other suitable means. Microwave sources that may be useful include, but are not limited to, the magnetron, Gunn and IMPATT diodes, klystron, gyrotron, and travelling wave tube. Sequential application of higher microwave power or different methods such as optical excitation by a laser may be used, in some cases, to liberate ions from the organic matrix. In some embodiments, neutral vapors are exclusively liberated or liberated in concert with ionic materials. These neutral vapors may be independently detected, form complexes with ions for detection, and/or be subsequently ionized for detection.

In some embodiments, carbon, metals, oxide materials, and/or nanoparticles may be used to form or as solid supports. In some embodiments, molecules (e.g., chemical tag(s)) may be covalently attached to the solid supports. In the case of carbon-based materials, functionalization of the solid support may be performed by cycloaddition reactions, reactions with carbenes, reactions with nitrenes, reactions with diazonium ions, reactions with organometallics, or by reductive alkylation. In some embodiments, oxidized materials including graphene oxide and oxidized carbon nanotubes are functionalized by reactions with amines or alcohols (e.g., resulting in new graphene oxide-O or —N bonds). In some embodiments, oxidized carbon-based materials may comprise carboxylic acid groups that may be transformed into esters or amides. In some embodiments, metal nanoparticles and surfaces, may be functionalized by addition of thiols, phosphines, N-heterocyclic carbenes, organic halides, ylides, nitroaromatics, and other species. In some embodiments, metal oxides are readily functionalized by amines, phosphates, phosphonates, carboxylates and siloxanes. In some embodiments, as described herein, the chemical tag(s) attached to solid supports yield a vapor and/or volatile ion with excitation.

In some embodiments, physisorption of chemical tag(s) as coatings onto carbons, metal oxides, metal nanoparticles, or metal surfaces may also be used. Such coatings may be polymeric, molecular, or combinations thereof. In some embodiments, the coatings contain ionic species (e.g., organic ionic species, inorganic ionic species) suitable to be volatized for analysis. One of ordinary skill in the art will recognize, based upon the teachings of this specification, how to develop materials that will form non-covalent complexes with molecules, molecular ions, and ions. For example, activated forms of carbon may be used to absorb an organic chemical tag(s) and/or may be used to extract ions from materials. As an illustrative example, activated carbons are used for the purification of drinking water from organic pollutants and toxic metal ions and may be used to create encoded materials that may be used to generate volatile ions as authentication codes, as described herein.

In some embodiments, the functionalized material(s) may be characterized as ionic. As an illustrative example, a pyridyl linkage may be attached to a material through a carbon-carbon bond or through an amide linkage, such that the pyridyl nitrogen may be functionalized (e.g., by addition of an acid group to form a salt with the conjugate base of the acid serving as the counterion, or may be alkylated). In some cases, the pyridinium cation may have a diversity of anions for change balance. Activation of a solid support may, in some cases, liberate ionic species that are the counterions or potentially fragments from the covalently bound ionic species.

By way of another illustrative example, carboxylic acid groups may be bound to a surface and a variety of cations could be paired with these species to create taggant species that may be ionized in a variety of ways to create unique authentication codes.

In some embodiments, for a particular chemical tag, two or more methods may be used to release the ionic species for analysis. For example, a first soft ionization method may be used to release formed counter ions, and a second higher energetic stimulation may be used to release a wider range of ionic species.

In some embodiments, the use of preformed ions may be useful to determine the charge of the ionic species generated. For example, in one stimulated release cationic authentication signals may be generated while in another case anionic authentication signals may be generated. Additional layers of authentication are envisioned wherein one group of users employs a method to read the authentication wherein another group uses another method. Such methods may be used, in some cases, to accommodate the reader/hardware that is used at different locations e.g., such that the authentication codes not be critically associated with a particular infrastructure. In some embodiments, taggants may be developed that may have a diversity of authentication signatures that are coupled with the methods for which the volatized ionic materials are generated and measured. In some such embodiments, spatial coding may be used such that taggants are patterned in visible or invisible patterns (e.g., which may also function as one- of two-dimensional barcodes that may reveal information that is read by the ionic signatures generated or by a standard optical barcode or matrix code method).

In some embodiments, one or more chemical tag(s) each contain different information. For example, a first chemical tag may contain a material that is configured to thermally desorb over time. In some such embodiments, if the material is exposed to heat outside of the recommended limits for the article, a particular taggant may be depleted. In some embodiments, there may still be adequate information in the other codes that are persistent to authenticate the article, but in this case the method also provides a characteristic of the article related to the history of the article. In some embodiments, the chemical tag comprises a material configured to change in the presence of (excessive) heat, (excessive) humidity, pesticides, UV light, organic vapors, ionizing radiation, sterilization processes, or physical stress. In some such embodiments, the taggants may be used for quality control and to ensure that the products are in good condition for the intended user.

In some embodiments, the label comprises additives (e.g., spatially patterned materials) such that the generated authentication signal is characterized by the identity of the volatile ion components and/or their position in the article. In some embodiments, the energy source used for volatilization and/or ionization of the chemical tag may be moved through space in a defined pattern such that the detection event(s) occurs in a designed fashion. In some embodiments, chemical additives may be used in the label to suppress or assist ionization. In some such embodiments, the patterning of such additives may contribute the complexity of the authentication signal. In some embodiments, the chemical composition of the article may be patterned to vary as a function of depth, such that in the occurrence of ionization of the top of the material reveals additional layers underneath for added complexity.

In some cases, the detector may determine changes in a condition, or set of conditions, of a surrounding medium. As used herein, a change in a “condition” or “set of conditions” may comprise, for example, change to a particular temperature, pH, solvent, chemical reagent, type of atmosphere (e.g., nitrogen, argon, oxygen, etc.), electromagnetic radiation, or the like. In some cases, the set of conditions may include a change in the temperature of the environment in which the detector is placed. For example, the detector may include a component (e.g., binding site) that undergoes a chemical or physical change upon a change in temperature, producing a determinable signal from the detector.

As used herein, an “analyte” or “chemical compound” can be any chemical, biochemical, or biological entity (e.g. a molecule) to be analyzed. The analyte may be in vapor phase, liquid phase, or solid phase. In some embodiments, the analyte is a vapor phase analyte. In some cases, the analyte may be a form of electromagnetic radiation. In some cases, the analyte may be airborne particles.

In some cases, the species generating the ionic signature for detection comprises an aromatic species. As used herein, an “aromatic species” includes unsubstituted or substituted, monocyclic or polycyclic aromatic ring or ring radical, including unsubstituted or substituted monocyclic or polycyclic heteroaromatic rings or ring radicals (e.g., aromatic species including one or more heteroatom ring atoms). Examples of aromatic species include phenyl, naphthyl, anthracenyl, chrysenyl, fluoranthenyl, fluorenyl, phenanthrenyl, pyrenyl, perylenyl, and the like.

The term “substituted” is contemplated to include all permissible substituents of organic compounds, “permissible” being in the context of the chemical rules of valence known to those of ordinary skill in the art. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl” must still comprise the phenyl moiety and cannot be modified by substitution, in this definition, to become, e.g., a heteroaryl group such as pyridine. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

Examples of substituents include, but are not limited to, alkyl, aryl, aralkyl, cyclic alkyl, heterocycloalkyl, hydroxy, alkoxy, aryloxy, perhaloalkoxy, aralkoxy, heteroaryl, heteroaryloxy, heteroarylalkyl, heteroaralkoxy, azido, amino, halogen, alkylthio, oxo, acylalkyl, carboxy esters, carboxyl, carboxamido, nitro, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, alkoxyalkyl, perhaloalkyl, arylalkyloxyalkyl, and the like.

### EXAMPLES

The following examples generally demonstrate the collection of data for identification of individual components in mixtures, sampled from various substrates, and dual-identification of a sample via Mass Spectrometry and fluorescence detection.

A DART/MS instrument was used to collect data demonstrating identification of individual components in mixtures, sampled from various substrates, and dual-identification of a sample via Mass Spectrometry and fluorescence detection (e.g., using a FIDO® X3 instrument).

Samples (10 mg/mL dissolved in isopropyl alcohol) of various materials (see Table 1) were prepared, drop cast (10 μL) onto various substrates, and allowed to dry.

1. Analyte mixtures
a. 3-Component mixtures
   i. Mixture of benzyl alcohol/methyl salicylate/ethyl laurate drop cast onto paper and air dried
   ii. Mixture of trans-cinnamaldehyde/octyl acetate/ethyl decanoate drop cast onto paper and air dried
b. 5-Component mixture
   i. Mixture of benzoic acid/p-anisaldehyde/octyl acetate/ethyl decanoate/ethyl laurate drop cast onto paper and air dried

2. Alternative substrates
a. 3- and 5-component mixtures drop cast onto aluminum foil, Nomex, or Teflon and air dried

TABLE 1

| | CAS Number | Sample | MW | BP (° C.) |
|---|---|---|---|---|
| 1 | 100-51-6 | Benzyl Alcohol | 108 | 205 |
| 2 | 65-85-0 | Benzoic Acid | 122 | 250 |
| 3 | 14371-10-9 | Trans-Cinnamaldehyde | 132 | 248 |
| 4 | 123-11-5 | p-Anisaldehyde | 136 | 248 |
| 5 | 119-36-8 | Methyl Salicylate | 152 | 222 |
| 6 | 112-14-1 | Octyl Acetate | 172 | 203 |
| 7 | 110-38-3 | Ethyl decanoate | 200 | 245 |
| 8 | 106-33-2 | Ethyl Laurate | 214 | 262 |

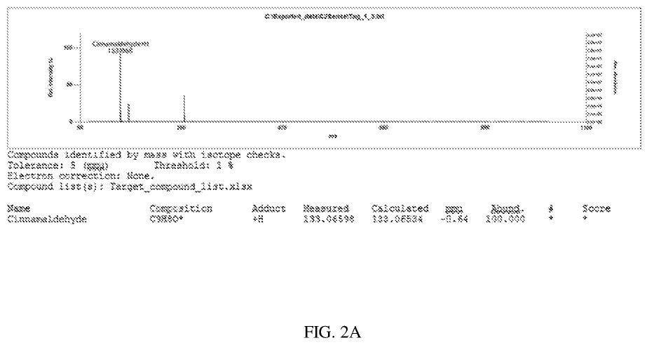

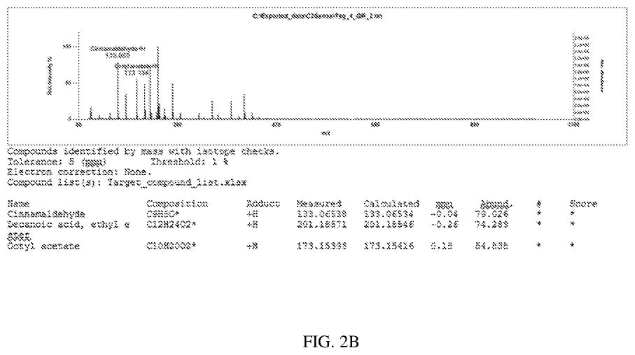

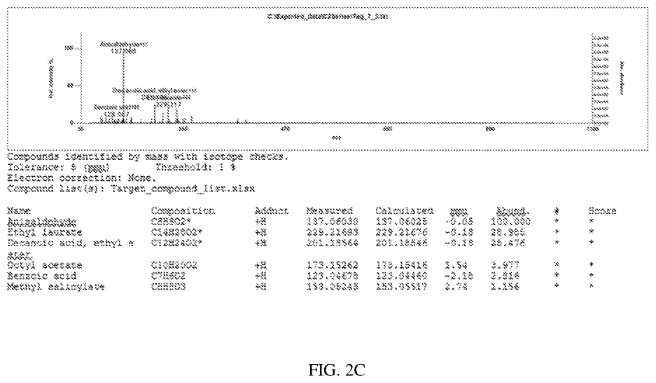

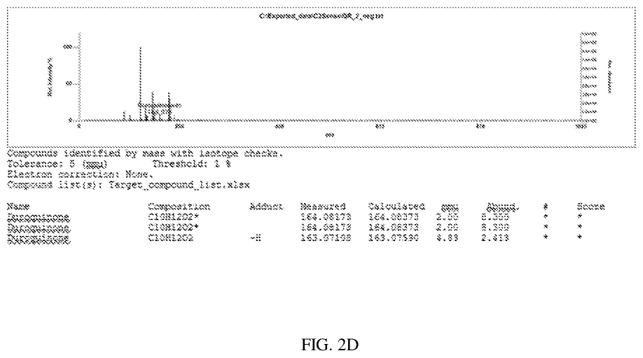

The samples were tested by exposure to the stream of ions produced by the DART source, their spectra recorded, and their components subsequently analyzed. Representative examples:
1) A single component sample of cinnamaldehyde drop cast onto paper was analyzed by DART/MS and identified (see FIG. 2A).
2) A 3-component sample of cinnamaldehyde, ethyl decanoate, and octyl acetate was drop cast onto paper and analyzed by DART/MS and identified (see FIG. 2B).
3) A 5-component sample of anisaldehyde, ethyl laurate, ethyl decanoate, octyl acetate, and benzoic acid was drop cast onto paper and analyzed by DART/MS and identified. The extra component identified (methyl salicylate) is the result of sample cross contamination (see FIG. 2C).
4) A single component sample of duroquinone was inkjet printed into a QR code format and analyzed by DART/MS and identified. The sample was previously identified by fluorescence detection using a FIDO® X3 instrument (see FIG. 2D).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, and/or geometric relationship include, but are not limited to terms descriptive of: shape—such as, round, square, gomboc, circular/circle, rectangular/rectangle, triangular/triangle, cylindrical/cylinder, elliptical/ellipse, (n)polygonal/(n)polygon, etc.; angular orientation—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; direction—such as, north, south, east, west, etc.; surface and/or bulk material properties and/or spatial/temporal resolution and/or distribution—such as, smooth, reflective, transparent, clear, opaque, rigid, impermeable, uniform(ly), inert, non-wettable, insoluble, steady, invariant, constant, homogeneous, etc.; as well as many others that would be apparent to those skilled in the relevant arts. As one example, a fabricated article that would described herein as being “square” would not require such article to have faces or sides that are perfectly planar or linear and that intersect at angles of exactly 90 degrees (indeed, such an article can only exist as a mathematical abstraction), but rather, the shape of such article should be interpreted as approximating a “square,” as defined mathematically, to an extent typically achievable and achieved for the recited fabrication technique as would be understood by those skilled in the art or as specifically described. As another example, two or more fabricated articles that would described herein as being “aligned” would not require such articles to have faces or sides that are perfectly aligned (indeed, such an article can only exist as a mathematical abstraction), but rather, the arrangement of such articles should be interpreted as approximating “aligned,” as defined mathematically, to an extent typically achievable and achieved for the recited fabrication technique as would be understood by those skilled in the art or as specifically described.

1. A label, comprising:
a means for associating the label with an article; and
a tag associated with the label, the tag comprising at least one analyte capable of generating an ionic species under a set of conditions,
wherein the ionic species is associated with a characteristic of the article, and
wherein the ionic species is identifiable by mass and/or ion mobility spectrometry.

2. A method for identifying a characteristic of an article, comprising:
ionizing or volatilizing an analyte associated with the article such that one or more ions are generated, the analyte having been proactively added to the article; and
detecting the presence of the one or more ions, wherein the detection or absence of the one or more ions identifies a characteristic of the article.

3. A method as in claim 2, wherein the step of detecting comprises using mass and/or ion mobility spectrometry.

4. (canceled)

5. A system configured for identification of an article, comprising:
a label associated with the article, the label comprising a tag;
the tag comprising one or more analytes capable of generating an ionic species under a set of conditions; and
a component configured for volatizing the analyte such that the ionic species is generated;
wherein presence or absence of the one or more ionic species is configured to be detected, by a detector, the detector comprising a mass or ion mobility spectrometry component, and
wherein the one or more ionic species are associated with a characteristic of the article.

6. A label as in claim 1, wherein the label further comprises a marker comprising an optical barcode, watermark, hologram, RFID, invisible ink, dyes, colorimetric markers, fluorescent markers, nanoparticles, nanorods, quantum dots, antibodies, proteins, and/or nucleic acids.

7. A label as in claim 1, wherein the at least one analyte comprises two more types of ionic species.

8. A label as in claim 1, wherein the at least one analyte is applied at a plurality of spatially-distinct locations.

9. A method as in claim 2, wherein the analyte is non-volatile prior to triggering.

10. A label as in claim 1, wherein the characteristic corresponds to product identification, authentication, serialization, point of origin, track & trace, diversion of goods, counterfeit identification, adulterated product identification, regulatory compliance, inventory and/or logistics management, product age, product quality, and/or legal document authentication of the article.

11. A label as in claim 1, wherein the label comprises a second identifiable component.

12. A label as in claim 11, wherein the second identifiable component comprises an optical barcode, hologram, watermark, RFID, invisible ink, dyes, colorimetric markers, fluorescent markers, nanoparticles, nanorods, quantum dots, antibodies, proteins, nucleic acids, or combinations thereof.

13. A label as in claim 1, wherein the chemical tag is activated or degraded by the presence of water, reactive chemicals, sterilization process, or excessive temperature.

14. A label as in claim 1, wherein the ionic species comprises positive ions.

15. A label as in claim 1, wherein the ionic species comprises negative ions.

16. A method, as in claim 2, wherein volatilizing comprises matrix assisted laser desorption ionization (MALDI) or surface assisted laser desorption ionization (SALDI).

17. A method, as in claim 2, wherein a vapor is first volatized and then ionized to allow detection.

18. A method, as in claim 2, wherein particles are aerosolized from the tag and one or more ionic species are then generated to allow detection.

19-20. (canceled)

21. A label as in claim 1, wherein the tag comprises a reactive matrix material configured to generate one or more ions.

22. A label as in claim 1, wherein the tag comprises a thermal fragmentation component configured to generate one or more ions.

23. A label as in claim 1, wherein the label comprises a chemically encoded barcode formed via printing, mechanical abrasion, or embedding on the article.
